(19) United States
(12) Patent Application Publication
(10) Pub. No.: US 2021/0307132 A1
(43) Pub. Date: Sep. 30, 2021

(54) HIGH-FREQUENCY DIELECTRIC HEATING DEVICE AND RECORDING APPARATUS

(71) Applicant: SEIKO EPSON CORPORATION, Tokyo (JP)

(72) Inventor: Tadashi AIZAWA, Matsumoto-shi (JP)

(21) Appl. No.: 17/215,815

(22) Filed: Mar. 29, 2021

(30) Foreign Application Priority Data
Mar. 31, 2020 (JP) 2020-062275

(51) Int. Cl. H05B 6/66; H05B 6/72

(52) U.S. Cl. CPC H05B 6/664; B41J 2/355; H05B 6/72

(57) ABSTRACT

A high-frequency dielectric heating device includes a high-frequency power source generating a high-frequency voltage, a first resonance circuit electrically coupled to the high-frequency power source and outputting a first resonance voltage based on the high-frequency voltage, and an antenna having a capacitor including a first electrode and a second electrode and a coil, electrically coupled to the first resonance circuit, and supplied with the first resonance voltage, wherein one end of the coil is electrically coupled to the first electrode and the other end is electrically series-coupled to the first resonance circuit, the first resonance circuit includes a capacitor having fixed capacitance, a resonance frequency of the first resonance circuit is different from a resonance frequency of the antenna, a frequency range in which a return loss of the first resonance circuit is equal to or less than 0.1 dB and a frequency range in which a return loss of the antenna is equal to or less than 0.1 dB overlap, and a frequency of the high-frequency voltage is in the frequency range in which the return loss of the first resonance circuit is equal to or less than 0.1 dB.

The present application is based on, and claims priority from JP Application Serial Number 2020-062275, filed Mar. 31, 2020, the disclosure of which is hereby incorporated by reference herein in its entirety.

### BACKGROUND

### 1. Technical Field

The present disclosure relates to a high-frequency dielectric heating device and a recording apparatus.

### 2. Related Art

Various types of recording apparatuses are developed. Further, not only the recording apparatuses but also configurations of the recording apparatuses are respectively studied. For example, a mechanism of early drying ink attached to a recording medium is studied. For example, JP-A-2018-010842 discloses a high-frequency dielectric heating device that dielectrically heats and dries attached ink by applying an alternating-current electric field to a medium.

However, a liquid to be dried acts as a part of a heater (antenna) of the high-frequency dielectric heating device and, as a result, heating efficiency of the high-frequency dielectric heating device changes depending on the shape and the composition of the liquid.

Or, when a heater (antenna) of a compact high-frequency dielectric heating device is used for a recording apparatus, it is necessary to heat while moving the heater relative to a recording medium, and the relative movement speed between the recording medium and the high-frequency dielectric heating device rises as the recording speed is higher. Thereby, the heating efficiency of the high-frequency dielectric heating device changes fast and complexly.

Regarding the heating efficiency of the high-frequency dielectric heating device, impedance of the heater changes due to changes in shape and composition of the liquid to be heated, and thereby, a signal transmission quantity from a high-frequency signal source to the heater changes and varies. Accordingly, the impedance of the heater is changed to follow the shape and the composition of the liquid and the heating efficiency may be constantly maximized. When the changes in shape and composition of the liquid are faster, a large load may be generated on a matching box for adjustment of the impedance and control thereof.

### SUMMARY

An aspect of a high-frequency dielectric heating device according to the present disclosure includes a high-frequency power source generating a high-frequency voltage, a first resonance circuit electrically coupled to the high-frequency power source and outputting a first resonance voltage based on the high-frequency voltage, and an antenna having a capacitor including a first electrode and a second electrode and a coil, electrically coupled to the first resonance circuit, and supplied with the first resonance voltage, wherein one end of the coil is electrically coupled to the first electrode and the other end is electrically series-coupled to the first resonance circuit, the first resonance circuit includes a capacitor having fixed capacitance, a resonance frequency of the first resonance circuit is different from a resonance frequency of the antenna, a frequency range in which a return loss of the first resonance circuit is equal to or less than 0.1 dB and a frequency range in which a return loss of the antenna is equal to or less than 0.1 dB overlap, and a frequency of the high-frequency voltage is in the frequency range in which the return loss of the first resonance circuit is equal to or less than 0.1 dB.

An aspect of a recording apparatus according to the present disclosure includes the high-frequency dielectric heating device according to the above described aspect, a carriage, and a liquid ejection head, wherein at least a heater of the high-frequency dielectric heating device and the liquid ejection head are mounted on the carriage, and a thin film of a liquid ejected from the liquid ejection head and attached to a recording medium is dried by the high-frequency dielectric heating device.

### BRIEF DESCRIPTION OF THE DRAWINGS

FIG. 1 is a schematic diagram around electrodes of a high-frequency dielectric heating device according to an embodiment.

FIG. 2 is an equivalent circuit diagram of the high-frequency dielectric heating device according to the embodiment.

FIG. 3 is a schematic diagram around electrodes of a high-frequency dielectric heating device according to an embodiment.

FIG. 4 is an equivalent circuit diagram of the high-frequency dielectric heating device according to the embodiment.

FIG. 5 is a schematic diagram of a main part of a recording apparatus according to an embodiment.

FIG. 6 is a graph showing frequency characteristics of a return loss of an antenna.

FIG. 7 is a graph showing frequency characteristics of a return loss of a resonance circuit.

FIG. 8 is a graph showing frequency characteristics of a return loss of the high-frequency dielectric heating device.

FIG. 9 is a graph showing frequency characteristics of a return loss of the high-frequency dielectric heating device.

FIG. 10 is a graph of an electromagnetic field simulation of the antenna.

FIG. 11 is a graph of an electromagnetic field simulation of the resonance circuit.

FIG. 12 is a graph of an electromagnetic field simulation of the high-frequency dielectric heating device.

FIG. 13 is a Smith chart of impedance of the antenna.

FIG. 14 is a graph of frequency characteristics of a return loss of the antenna.

FIG. 15 is an equivalent circuit diagram of a high-frequency dielectric heating device according to an experimental example.

FIG. 16 shows energy transmission characteristics (C1=1.5 pF) from a high-frequency power source to a heated object according to the experimental example.

FIG. 17 shows energy transmission characteristics (C1=0.5 pF) from the high-frequency power source to the heated object according to the experimental example.

### DESCRIPTION OF EXEMPLARY EMBODIMENTS

As below, embodiments of the present disclosure will be explained. The embodiments to be described are for explanation of examples of the present disclosure. The present disclosure is not limited to the following embodiments, but includes various modified forms embodied in a range in which the gist of the present disclosure is not changed. Note that not all of the configurations to be described are necessarily essential configurations of the present disclosure.

### 1. High-Frequency Dielectric Heating Device

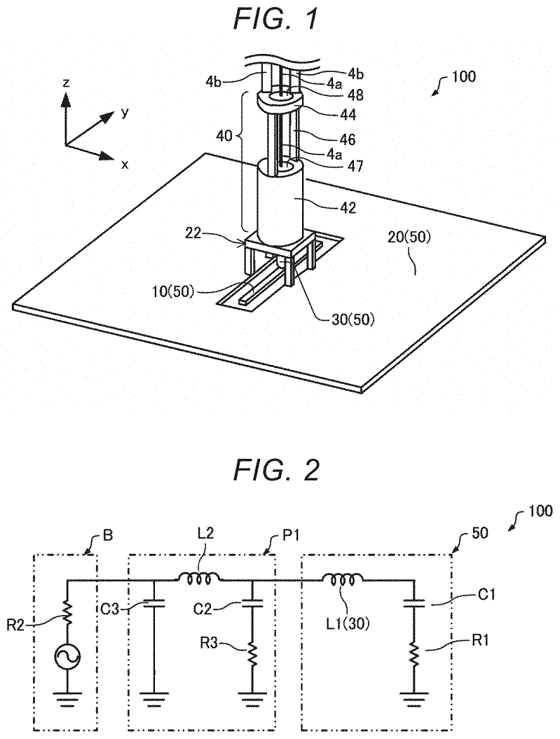

A high-frequency dielectric heating device according to an embodiment includes a high-frequency power source, a first resonance circuit, and an antenna. FIG. 1 is a schematic diagram of a high-frequency dielectric heating device 100 as an example of the high-frequency dielectric heating device according to the embodiment. FIG. 2 is an equivalent circuit diagram of the high-frequency dielectric heating device 100. The high-frequency dielectric heating device 100 has an electromagnetic wave generation unit including a first electrode 10, a second electrode 20, and a coil 30, and a first resonance unit 40 forming the first resonance circuit.

### 1.1. High-Frequency Power Source

The high-frequency dielectric heating device 100 of the embodiment includes the high-frequency power source. The high-frequency power source includes a high-frequency voltage generation circuit B. The high-frequency power source generates a high-frequency voltage applied to the antenna. The high-frequency power source (not shown in FIG. 1) includes e.g. a quartz crystal oscillator, a PLL (Phase Locked Loop) circuit, and a power amplifier. The high-frequency voltage generated by the high-frequency power source is supplied to the first resonance unit 40 via e.g. a coaxial cable.

A basic peripheral circuit configuration of the high-frequency power source of the high-frequency dielectric heating device 100 of the embodiment is a configuration that amplifies a high-frequency signal generated in the PLL using the power amplifier and supplies the signal to the antenna. In an antenna 50, when many sets of the first electrode 10 and the second electrode 20 are used, for example, one power amplifier is used for one set and the output of the PLL is divided and sent to the power amplifier, and thereby, electromagnetic wave may be individually generated. When a plurality of sets of the antenna and the power amplifier are used, high-frequency output of the respective antennas may be individually controlled more easily.

### 1.2. Antenna

The high-frequency dielectric heating device 100 according to the embodiment has the antenna 50. The antenna 50 has a capacitor C1 including the first electrode 10 and the second electrode 20 and the coil 30, and electrically coupled to the first resonance unit 40. Further, one end of the coil 30 is electrically coupled to the first electrode 10 or the second electrode 20 and the other end is electrically series-coupled to the first resonance unit 40.

### 1.2.1. First Electrode and Second Electrode

The high-frequency dielectric heating device 100 includes the first electrode 10 and the second electrode 20. The first electrode 10 and the second electrode 20 have conductivity. The first electrode 10 and the second electrode 20 form the capacitor C1. A reference potential is applied to one of the first electrode 10 and the second electrode 20. A high-frequency voltage is applied to the other of the first electrode 10 and the second electrode 20. The choice of the first electrode 10 and the second electrode 20 is arbitrary, and the reference potential is applied to one of the two electrodes and the high-frequency voltage is applied to the other. In this specification, the electrode to which the reference potential is applied may be referred to as “reference potential electrode” and the electrode to which the high-frequency voltage is applied may be referred to as “high-frequency electrode”.

The reference potential is a constant potential as a reference for the high-frequency voltage and may be e.g. a ground potential. As a special example, when the output of the high-frequency voltage generation circuit that generates the high-frequency voltage input to the high-frequency dielectric heating device 100 is a differential circuit, distinction between the first electrode 10 and the second electrode 20 is not necessary. Further, the coil 30 is not necessarily coupled to the first resonance circuit, but can be coupled to the reference potential. In this case, the electrode to which the coil is coupled is the first electrode and it is necessary to couple the second electrode to the first resonance circuit. Regarding the frequency of the high-frequency wave, when the frequency is equal to or higher than 1 MHz, a heating effect is obtained and, when the frequency is around 20 GHz and a heated object is water, the dielectric loss tangent thereof is the maximum and heating efficiency due to the dielectric loss tangent is the maximum. Particularly, from a viewpoint of heating of ink, even when the frequency is as low as e.g. 40.68 MHz, one of ISM bands, good heating efficiency may be obtained. This is because, although the dielectric loss tangent of the water in the ink is very low at 40.68 MHz, high heat generation is obtained by an ohmic loss due to an eddy current flowing in an electrical resistance of the ink. As the high-frequency voltage is higher, an amount of heat supplied to the liquid is larger. The voltage is normally transmitted to the high-frequency dielectric heating device 100 in a transmission line with 50Ω and expressed by “high-frequency power=V\hat{ }2/R=V\hat{ }2/50” at the high-frequency voltage input of the high-frequency dielectric heating device 100. Furthermore, to suppress an amount of heat generated in a parasitic resistance of the high-frequency dielectric heating device 100 and suppress generation of corona discharge, it is preferable to set electric power for one high-frequency dielectric heating device 100 to several hundreds of watts and secure electric power necessary for drying the liquid using a plurality of the high-frequency dielectric heating devices 100. The liquid is heated by dielectric heating by an electric field generated between the first electrode 10 and the second electrode 20. The electric field here takes a very large value of about 1×10\hat{ } 6 V/m. The electric field between the first electrode 10 and the second electrode 20 depends on arising voltage effect of the coil 30 and an effect of capacitance between electrodes.

Application of the high-frequency voltage refers to supply of electric power of the above described high-frequency voltage to a power supply point set in a center portion of a surface opposite to a surface facing the liquid in the first electrode 10 or the second electrode 20.

In the illustrated example, the first electrode 10 and the second electrode 20 have flat-plate shapes. The planar shapes of the first electrode 10 and the second electrode 20 are arbitrary and may be e.g. square shapes, rectangular shapes, circular shapes, or a combination of those shapes. Further, in the illustrated example, in a plan view, the second electrode 20 is placed to surround the first electrode 10. The plan view here refers to a state as seen from a direction along a z direction in FIG. 1. As described above, the second electrode surrounds the first electrode and a distance between the first electrode 10 and the second electrode is small relative to the wavelength of the electromagnetic wave at the used frequency, and thus, radiation of a distant electromagnetic field may be suppressed to be extremely small. Thereby, even when high-frequency wave at about 1 kW is radiated, exposure of people around can be kept at a safe level without using an electromagnetic shield.

The first electrode 10 of the high-frequency dielectric heating device 100 has an elongated rectangular shape in the plan view. In the high-frequency dielectric heating device 100, the second electrode 20 is formed in a hollow square shape so that the second electrode 20 may surround the first electrode 10 in the plan view. Though not illustrated, the first electrode 10 may be formed in a circular shape in the plan view and the second electrode 20 may be formed in an annular shape in the plan view, or may be formed in shapes with hexagonal outer peripheries. As a basic property, a strong electric field is concentrated on a corner portion of the rectangular shape of the first electrode 10 and induction of harmful corona discharge is highly likely here, and the shape is desirably a shape with less sharp corners.

Though not illustrated, both the first electrode 10 and the second electrode 20 may be formed in arbitrary shapes in the plan view and placed adjacently to each other. In this case, the planar sizes of the first electrode 10 and the second electrode 20 are, as an area in the plan view in one electrode, from 0.01 cm² to 100.0 cm², preferably from 0.1 cm² to 10.0 cm², more preferably from 0.5 cm² to 2.0 cm², and even more preferably from 0.5 cm² to 1.0 cm². The above described areas are areas when a frequency of 2.45 GHz is used and, as the used frequency is lowered, the areas are increased. The areas of the first electrode 10 and the second electrode 20 in the plan view may be the same or different.

In the high-frequency dielectric heating device 100, the high-frequency potential and the reference potential are respectively supplied to the first electrode 10 in the rectangular shape placed in the center portion in the plan view and the second electrode 20 in the hollow rectangular shape (frame shape) surrounding the first electrode 10. The coil 30 is inserted between the first electrode 10 and an inner conductor 4a of the coaxial cable and placed as close to the first electrode 10 as possible.

In the high-frequency dielectric heating device 100, when the second electrode 20 is formed in the hollow rectangular shape in the plan view, for example, a length of one side of the outer periphery is from 0.1 cm to 10.0 cm, preferably from 0.3 cm to 5.0 cm, and more preferably from 0.4 cm to 1.0 cm. Further, in this case, a width of the second electrode 20 in the plan view is from 0.1 mm to 2.0 mm, preferably from 1.4 mm to 1.6 mm, and more preferably about 1.5 mm. The above described lengths of one side of the outer periphery are lengths when a frequency of 2.45 GHz is used and, as the used frequency is lowered, the lengths are increased.

It is preferable that the first electrode 10 and the second electrode 20 are placed not to overlap in the plan view. In the illustrated example, the first electrode 10 and the second electrode 20 are placed in juxtaposition on the same plane. By the placement, predetermined electromagnetic wave may be efficiently generated.

The first electrode 10 and the second electrode 20 are formed by conductors. As the conductors, metals, alloys, conductive oxides, etc. may be exemplified. The materials of the first electrode 10 and the second electrode 20 may be the same or different. The first electrode 10 and the second electrode 20 may be appropriately formed with selected thicknesses and strengths for self standing structures, or, when the strengths are hard to be held, may be formed on surfaces of substrates formed using materials having low dielectric loss tangents that transmit electromagnetic wave (not shown) or the like. In the example of FIG. 1, the first electrode 10 and the second electrode 20 are electrically coupled to the high-frequency power source via the inner conductor 4a and an outer conductor 4b of the coaxial cable (not shown), respectively.

When the inner conductor 4a of the coaxial cable is electrically coupled to the first electrode 10 and the outer conductor 4b is coupled to the second electrode 20, it is preferable that a first resonance voltage is applied to the first electrode 10 and the reference potential is applied to the second electrode 20. In this manner, the high-frequency voltage is harder to be affected by disturbances including noise, and thereby, electric power may be applied to the antenna 50 more stably.

### 1.2.2. Distance Between Electrodes

It is preferable that the minimum separation distance between the first electrode 10 and the second electrode 20 is equal to or smaller than one tenth of the wavelength of the electromagnetic wave output from the high-frequency dielectric heating device 100. For example, when the frequency of the electromagnetic wave output from the high-frequency dielectric heating device 100 is 2.45 GHz, the wavelength of the high-frequency wave is about 12.2 cm and, in this case, it is preferable that the minimum separation distance between the first electrode 10 and the second electrode 20 is equal to or smaller than about 1.22 cm.

The minimum separation distance between the first electrode 10 and the second electrode 20 is equal to or smaller than one tenth of the wavelength of the output electromagnetic wave, and thereby, most of the electromagnetic wave generated when the high-frequency voltage is applied may be attenuated near the first electrode 10 and the second electrode 20. Thereby, intensity of the electromagnetic wave reaching a distant place from the first electrode 10 and the second electrode 20 may be reduced.

That is, the electromagnetic wave radiated from the high-frequency dielectric heating device 100 is very strong near the first electrode 10 and the second electrode 20 and very weak in a distant place. In this specification, the electromagnetic field generated near the first electrode 10 and the second electrode 20 by the high-frequency dielectric heating device 100 may be referred to as “near electromagnetic field”. Further, in this specification, the electromagnetic field generated by a typical antenna (aerial) for a purpose of transmitting electromagnetic wave to a distant place may be referred to as “far electromagnetic field”. The boundary between near and far is in a position apart by about one sixth of the wavelength of the generated electromagnetic wave from the high-frequency dielectric heating device 100.

The high-frequency dielectric heating device 100 is used in application on a television or a cellular phone and does not transmit electromagnetic wave at distances in meters, and the electric field density of the generated electromagnetic wave is attenuated to 30% or less of the electric field density between the first electrode 10 and the second electrode 20 while transmitting to a distance of one sixth of the wavelength. That is, the high-frequency dielectric heating device 100 is unsuitable for communications. Further, regarding the electromagnetic wave generated by the high-frequency dielectric heating device 100, the range of the electric field is suppressed because of the higher attenuation rate. Accordingly, unnecessary radiation is hard to be generated in a region at a larger distance from the apparatus than a distance of about the wavelength of the generated electromagnetic wave. Therefore, a response to restrictions by Radio Act or the like is unnecessary or easy, and, even when a response is necessary, scattering of electromagnetic wave around the high-frequency dielectric heating device 100 may be reduced by a simple electromagnetic shield or the like. The nature of the high-frequency dielectric heating device 100 is caused by the smaller electrode sizes, the smaller distance between the electrodes, the shapes of the second electrode surrounding the first electrode, etc.

In other words, the high-frequency dielectric heating device 100 of the embodiment is not an apparatus for generating the far electromagnetic field such as a dipole antenna, but corresponds to an apparatus for preventing generation of a far electromagnetic field by setting a slot width to be sufficiently small relative to the wavelength in a slot antenna in which negative and positive sides are inverted to those of the dipole antenna. The structure only generates an electric field like a capacitor, and the electric field does not secondarily generate a magnetic field. Accordingly, the so-called far electromagnetic field in which an electric field and a magnetic field are generated in a chain reaction and transmitted to a distant place is not generated.

### 1.2.3. Coil

The high-frequency dielectric heating device 100 includes the coil 30 and the coil 30 is series-coupled to the first electrode 10 or the second electrode 20 via an electric wire (not shown). The first electrode 10 or the second electrode 20 is coupled to a route to which the high-frequency voltage is applied via the coil 30. In the illustrated example, one end of the coil 30 is electrically coupled to the first electrode 10 and the other end is electrically series-coupled to the first resonance unit 40.

Heating energy efficiency for liquid of the coil 30 largely differs depending on the position of series insertion even with the same inductance, and it is desirable to place the coil in a location as close to the electrode as possible. The coil 30 may be omitted using a method of forming the first electrode 10 or the second electrode 20 in a meander shape to provide inductance to the electrode itself.

The antenna 50 of the high-frequency dielectric heating device 100 has the coil 30, and thereby, effects of matching of impedance between the first resonance circuit and the antenna 50, increase of the electric field generated between the electrodes, strengthening by adding the electric field generated in the coil 30 to the electric field generated between the electrodes may be expected. As below, the main functions and effects of the coil 30 will be explained.

### Role of Coil (1): Matching

Generally, a voltage applied to an antenna is transmitted to the antenna by a coaxial cable (e.g. characteristic impedance 50Ω). It is preferable that the impedance of the antenna is set to be the same as impedance of a generation circuit of a high-frequency voltage or the coaxial cable for transmission from the circuit to the antenna. The impedance of the antenna is set to be the same as or close to impedance of the cable or the like, and thereby, energy transmission efficiency is improved. On the other hand, when a sinusoidal high-frequency voltage is input to the antenna and impedance of the antenna and the high-frequency voltage generation circuit do not match, it is hard to input a signal to the antenna because the signal is reflected in a location where the impedance is discontinuous. Accordingly, in a coupling location between a coaxial cable in which the impedance is easily discontinuous and the antenna, the impedance of the antenna is adjusted by insertion of a matching circuit including a coil and a capacitor between an inner conductor of the coaxial cable and the electrode of the antenna or between an outer conductor and the electrode of the antenna, and thereby, the energy transmission efficiency is improved. The coaxial cable normally has 50Ω and the matching circuit is adjusted so that the antenna also has 50Ω. If the coaxial cable has imaginary impedance, the antenna is adjusted to have imaginary impedance conjugate thereto. The coil is the so-called matching coil.

Role of Coil (2): Increase of Electric Field Density between Electrodes

FIG. 2 shows an equivalent circuit of the high-frequency dielectric heating device 100. The capacitor C1 of the antenna 50 corresponds to a pair of the first electrode 10 and the second electrode 20, and a resistor R1 of the antenna 50 corresponds to a radiation resistance of radiated electromagnetic wave. The high-frequency power source corresponds to the high-frequency voltage generation circuit B and a resistor R2 of the high-frequency voltage generation circuit B is an internal resistance of the high-frequency voltage source. The high-frequency voltage generation circuit B and a coil L1 of the antenna 50 correspond to the coil 30 series-coupled to the first electrode 10 or the second electrode 20.

As described above, the antenna 50 contains the capacitor C1, and a specific resonance frequency may be obtained by coupling of the coil L in series to the capacitor C1. Further, the electric field generated between the first electrode and the second electrode may be strengthened by increase of the inductance of the coil L1 and decrease of capacitance of the capacitor C1 as small as possible and, as a result, heating efficiency is improved. The inductance of the coil L1 and the capacitance of the capacitor C1 are appropriately designed.

The radiation resistance is smaller (e.g. about 7Ω) relative to the impedance of the coaxial cable (e.g. about 50Ω) and the capacitance of the capacitor C1 apparently formed by the first electrode 10 and the second electrode 20 is e.g. about 0.5 pF.

It is known from a simulation that, in the high-frequency dielectric heating device 100, when the planar shapes of the first electrode 10 and the second electrode 20 are square shapes in 5 mm×5 mm, the minimum separation distance is 5 mm, and the coil L of 10 nH is series-coupled to the second electrode 20, when a voltage of 1 V is generated from the high-frequency voltage generation circuit B as shown in FIG. 2, a voltage applied to an antenna terminal (a voltage applied between a point at the coil L1 side of the capacitor C1 and GND) is about 2 V. Here, the resistor R1 shows the radiation resistance of the antenna. Further, it is known that, as the inductance of the coil L1 is higher, the higher voltage is applied to the antenna 50. As described above, the antenna 50 includes the first electrode 10 and the second electrode 20 and the coil L1 and the coil L1 is inserted in series with the coaxial cable, and thereby, the voltage between the electrodes of the antenna 50 may be increased. Thereby, the electric field between the first electrode 10 and the second electrode 20 becomes stronger. Thereby, the electric field applied to the liquid as the object to be heated becomes stronger and the liquid is heated very effectively. Here, a high voltage is generated at the first electrode 10 coupling terminal side of the coil, and a strong electric field may be generated between the coil and the first electrode 10 or between an electric wire coupling the coil L1 and the first electrode 10 and the second electrode. The electric field does not contribute to heating, and it is necessary to couple the coil and the first electrode at the shortest distance.

### Role of Coil (3): Strengthen by Adding Electric Field Generated in Coil to Electric Field Generated Between Electrodes

The coil 30 is generally formed as a winding wire of an electric wire of a metal such as copper having a length and this has an inductance component and a parasitic resistance. For example, when the inductance component is about 30 nH, the parasitic resistance is generally about 3Ω. A potential difference is generated between ends of the coil 30 by the inductance and the internal resistance and an electric field is generated in a location with the potential difference. As shown in FIG. 1, when the coil 30 is placed close to the first electrode 10, all of the increased voltages shown in the above described “Role of Coil (2)” are applied to the first electrode 10 and a strong electric field is generated near the first electrode 10. Further, when directions of the electric field of the coil 30 and the electric field generated between the first electrode 10 and the second electrode 20 are the same, the electric field generated in the coil 30 may overlap with the electric field generated between the first electrode 10 and the second electrode 20 and the electric field near the first electrode 10 may be made stronger. As described above, it is more effective that the coil 30 is placed as close to the first electrode 10 as possible. For the purpose, the shape of the first electrode 10 is formed in e.g. a meander shape with inductance and the same function as the coils is provided to the first electrode 10 itself, and thereby, the antenna 50 may contain the coil and the coil may be placed in a position very close to the first electrode 10 without placement of the coil 30.

### 1.3. First Resonance Circuit

The first resonance circuit is electrically coupled to the high-frequency power source and outputs the first resonance voltage based on the high-frequency voltage input from the high-frequency power source. The first resonance circuit includes the first resonance unit 40. As shown in FIG. 1, the first resonance unit 40 includes a tubular conductor 42 in a circular cylindrical shape, an annular conductor 44 in a ring shape, and a columnar conductor 46 electrically coupling the tubular conductor 42 and the annular conductor 44, the inner conductor 4a placed to penetrate the tubular conductor 42 and the annular conductor 44, and an insulator 47 placed between the tubular conductor 42 and the inner conductor 4a.

The tubular conductor 42 is electrically coupled to a coupling portion 22 of the second electrode 20 and the columnar conductor 46. The annular conductor 44 is electrically coupled to the columnar conductor 46 and the outer conductor 4b. The first resonance unit 40 generates the first resonance voltage and the first resonance voltage is supplied to the antenna 50. Note that an insulator may be placed between the columnar conductor 46 and the inner conductor 4a.

In the equivalent circuit shown in FIG. 2, a first resonance circuit P1 includes a capacitor C2, a capacitor C3, a coil L2, and a resistor R3. The capacitor C2 shows the insulator 47 placed between the inner conductor 4a and the tubular conductor 42, and the capacitor C3 shows an insulator 48 placed between the inner conductor 4a and the annular conductor 44. Further, the coil L2 shows inductance (not shown) equivalently generated by the inner conductor 4a.

The inner conductor 4a penetrating the tubular conductor 42 and the annular conductor 44 is supported by resins or the like with respect to the tubular conductor 42 and the annular conductor 44 and held at a center of the tube or the ring. The resins or the like have properties as dielectric materials and form additional components of the capacitor C2 and the capacitor C3. Thereby, an equivalent loss as a dielectric loss tangent is produced. The equivalent loss is shown by the resistor R3 in the equivalent circuit in FIG. 2. Therefore, the resistor R3 is not shown as an object in FIG. 1.

The details will be described in examples. The resistor R1 of the equivalent circuit in FIG. 2 has the following significance regarding a return loss of the entire antenna. The return loss when the first resonance voltage is supplied from the first resonance circuit P1 to the antenna 50 depends on the frequency of the high-frequency power source. For example, the return loss becomes the minimum around the resonance frequency of the first resonance circuit and/or the antenna 50. Without the resistor R1, the impedance of the antenna has only the imaginary component and the frequency at which the return loss becomes the minimum is not generated. Further, the resistor R3 is a loss until the electric energy output from the high-frequency power source turns into heat energy in a heated object such as ink, and it is necessary to adjust the dielectric loss tangent and the shape of the used material to make the loss as small as possible.

Capacitance of both the capacitor C2 and the capacitor C3 in the first resonance circuit P1 is fixed. In the high-frequency dielectric heating device 100 of the embodiment, it is unnecessary to make the capacitance of the capacitor C2 and the capacitor C3 variable. Thereby, e.g. the manufacturing cost may be reduced. Even when the capacitance of both the capacitor C2 and the capacitor C3 is fixed, the antenna 50 may be driven sufficiently efficiently as long as a relationship of the return loss, which will be described later, is satisfied.

Further, in the first resonance circuit P1, the coil L2 and the capacitor C2 and capacitor C3 are coupled in a π-shape. According to the above described configuration, the resonance circuit that may respond to impedance of various antennas 50 may be obtained.

### 1.4. Relationship Between Resonance Frequency and Return Loss of Respective Configurations

In the high-frequency dielectric heating device 100 of the embodiment, the resonance frequency of the first resonance circuit P1, i.e., the first resonance unit 40 is different from the resonance frequency of the antenna 50, and the above described two frequency peaks may be obtained in the return loss of the high-frequency dielectric heating device 100 as seen from the high-frequency power source. Here, the dimensions, the materials, and the capacitance of the above described respective configurations are selected so that the resonance frequencies of them may be different from each other. Although the resonance frequency of the high-frequency power source should be supplied as the resonance frequency of the antenna in a normal situation, the resonance frequency of the high-frequency power source is supplied as the resonance frequency of the first resonance circuit P1. The resonance frequency of the antenna 50 largely varies depending on the shape and the composition of the heated object. On the other hand, the resonance frequency of the first resonance circuit P1 largely depends on a fixed constant within the resonance circuit and is more stable than the resonance frequency of the antenna. When the resistor R3 is smaller, the resonance frequency of the high-frequency power source may be supplied as the resonance frequency of the antenna 50 or the resonance frequency of the first resonance circuit P1. Thereby, the antenna 50 may be driven at the resonance frequency of the first resonance circuit P1 and heating may be stably performed at the resonance frequency in less variations with changes of the heated object.

Further, a frequency range in which the return loss of the first resonance circuit P1 is equal to or less than 0.1 dB and a frequency range in which the return loss of the antenna 50 is equal to or less than 0.1 dB are designed to overlap. Furthermore, the frequency of the high-frequency voltage supplied from the high-frequency power source is designed in the frequency range in which the return loss of the first resonance circuit P1 is equal to or less than 0.1 dB.

### 1.5. Multistage Configuration

The high-frequency dielectric heating device 100 may include a second resonance circuit P2 electrically coupled between the high-frequency power source, i.e., the high-frequency voltage generation circuit B and the first resonance circuit P1 and outputting a second resonance voltage based on the high-frequency voltage of the high-frequency power source. Similarly, the apparatus may include a third or more resonance circuits (not shown).

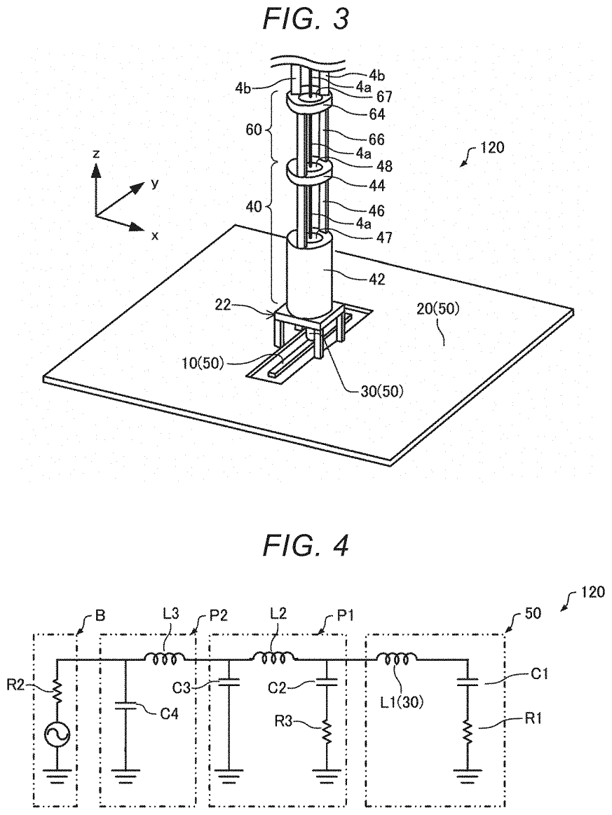

FIG. 3 is a schematic diagram of a high-frequency dielectric heating device 120 as an example of the high-frequency dielectric heating device according to the embodiment. FIG. 4 is an equivalent circuit diagram of the high-frequency dielectric heating device 120. The high-frequency dielectric heating device 120 has the electromagnetic wave generation unit including the first electrode 10, the second electrode 20, and the coil 30, the first resonance unit 40 forming the first resonance circuit, and further has a second resonance unit 60 forming a second resonance circuit electrically coupled between the high-frequency power source and the first resonance unit 40 and outputting a second resonance voltage based on the high-frequency voltage of the high-frequency power source.

The high-frequency power source and the antenna of the high-frequency dielectric heating device 120 are the same as those of the above described high-frequency dielectric heating device 100 and have the same signs and the explanation thereof will be omitted. The high-frequency dielectric heating device 120 is different from the above described high-frequency dielectric heating device 100 in that the device includes the second resonance unit 60 forming the second resonance circuit P2.

The second resonance circuit P2 is electrically coupled between the high-frequency power source, i.e., the high-frequency voltage generation circuit B and the above described first resonance circuit P1 and outputs the second resonance voltage based on the high-frequency voltage input from the high-frequency power source. The second resonance circuit P2 includes the second resonance unit 60. As shown in FIG. 3, the second resonance unit 60 includes an annular conductor 64 in a ring shape, a columnar conductor 66 electrically coupling the annular conductor 44 and the annular conductor 64, the inner conductor 4a placed to penetrate the annular conductor 44 and the annular conductor 64, and the insulator 48 placed between the inner conductor 4a and the annular conductor 44.

The annular conductor 64 is electrically coupled to the columnar conductor 66 and the outer conductor 4b. The second resonance unit 60 generates the second resonance voltage and the second resonance voltage is supplied to the first resonance unit 40. Further, the first resonance unit 40 forming the first resonance circuit P1 outputs the above described first resonance voltage based on the second resonance voltage and the antenna 50 is driven by the first resonance voltage. Note that an insulator may be placed between the columnar conductor 66 and the inner conductor 4a.

In the equivalent circuit shown in FIG. 4, the second resonance circuit P2 includes a capacitor C4 and a coil L3. The capacitor C4 shows an insulator 67 in FIG. 3. Further, the coil L3 shows inductance parasitically generated by the inner conductor 4a.

The capacitor C4 in the second resonance circuit P2 has fixed capacitance. In the high-frequency dielectric heating device 120 of the embodiment, it is unnecessary to make the capacitance of the capacitor C4 variable. Thereby, e.g. the manufacturing cost may be reduced. Even when the capacitance of the capacitor C4 is fixed, the antenna 50 may be driven sufficiently efficiently as long as a relationship of the return loss, which will be described later, is satisfied.

Further, the coil L3 and the capacitor C4 of the second resonance circuit P2 and the capacitor C3 of the first resonance circuit P1 are coupled in a π-shape. According to the above described configuration, the resonance circuit that may respond to impedance of various antennas 50 may be obtained.

In the high-frequency dielectric heating device 120 of the embodiment, the resonance frequency of the second resonance circuit P2, i.e., the second resonance unit 60 is different from the resonance frequency of the first resonance circuit P1. The dimensions, the materials, and the capacitance of the above described respective configurations are selected so that the resonance frequencies of them may be different from each other. Thereby, the antenna 50 may be driven at the resonance frequencies of the second resonance circuit P2 and the first resonance circuit P1 and the resonance frequency of the antenna 50 may be dominantly determined by the second resonance circuit P2 and the first resonance circuit P1.

Further, a frequency range in which a return loss of the second resonance circuit P2 is equal to or less than 0.1 dB and a frequency range in which the return loss of the first resonance circuit P1 is equal to or less than 0.1 dB are designed to overlap. Furthermore, the frequency of the high-frequency voltage supplied from the high-frequency power source is designed in the frequency range in which the return loss of the second resonance circuit P2 is equal to or less than 0.1 dB.

The high-frequency dielectric heating device 120 includes the two resonance circuits. The resonance circuits are parallel-coupled to the antenna 50, and the device is harder to be affected by variations of the resonance frequency of the antenna 50 and variations of the impedance. Further, the plurality of resonance circuits are parallel-coupled, and thereby, the resonance frequencies of the resonance circuits of the high-frequency dielectric heating device 120 are more dependent on the fixed constant and the dependency on the varying constant of the antenna 50 becomes lower and stable. Thereby, the antenna 50 is driven at the resonance frequency of the parallel resonance circuit and heating may be stably performed at the resonance frequency in less variations with changes of the heated object.

### 2. Recording Apparatus

A recording apparatus of an embodiment includes the above described high-frequency dielectric heating devices, a carriage, and a liquid ejection head. The high-frequency dielectric heating devices and the liquid ejection head are mounted on the carriage, and an ink thin film of ink ejected from the liquid ejection head and attached to a recording medium is dried by the high-frequency dielectric heating devices. As below, the carriage and the liquid ejection head will be sequentially explained.

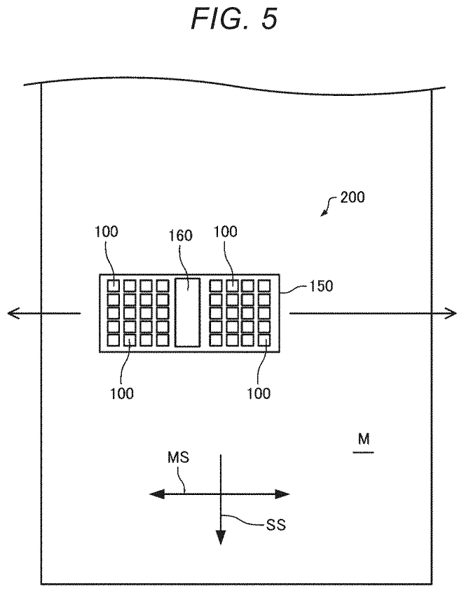

FIG. 5 is a schematic diagram of a main part of a recording apparatus 200 of the embodiment. FIG. 5 shows a carriage 150 and a recording medium M. The recording apparatus 200 includes the high-frequency dielectric heating devices 100, a liquid ejection head 160, and the carriage 150.

The recording apparatus 200 includes the liquid ejection head 160 and the plurality of high-frequency dielectric heating devices 100 on the carriage 150. The high-frequency dielectric heating devices 100 and the liquid ejection head 160 are mounted on the carriage 150. The recording apparatus 200 includes a high-frequency power source (not shown) that drives the respective high-frequency dielectric heating devices 100. Further, the plurality of high-frequency dielectric heating devices 100 are placed to cover an area equal to or larger than the length of nozzle rows (not shown) of the liquid ejection head 160 in a movement direction SS of the recording medium M. The recording apparatus 200 is a serial printer and has a mechanism of moving the recording medium M and a mechanism of reciprocating the carriage 150.

The recording apparatus 200 repeatedly moves and places the recording medium M in predetermined positions and ejecting and attaching the ink from the liquid ejection head 160 to predetermined positions of the recording medium M in predetermined amounts while scanning with the carriage 150 in directions crossing the movement direction SS of the recording medium M at a plurality of times, and thereby, forms a predetermined image on the recording medium M.

The high-frequency dielectric heating devices 100 are placed within the carriage 150 on one side or both sides of the liquid ejection head 160 in scanning directions MS of the carriage 150. In the illustrated example, pluralities of high-frequency dielectric heating devices 100 are respectively placed on both sides of the liquid ejection head 160 in the scanning directions MS. According to the arrangement, the liquid ejected from the liquid ejection head 160, attached to the recording medium M, and turned into the thin film may be early dried in a short time after a lapse of time according to a movement speed of the carriage 150, a distance from the nozzle of the liquid ejection head 160 to the high-frequency dielectric heating devices 100 in the scanning directions MS, etc.

In FIG. 5, the high-frequency dielectric heating devices 100 are placed in four rows on both sides of the liquid ejection head 160 in the scanning directions MS of the carriage 150. This is because, in a condition that high-frequency power of 9 W is input to the high-frequency dielectric heating devices 100 for drying the ink thin film, 1/20 seconds are necessary, however, a time for the high-frequency dielectric heating devices 100 in 5 mm to pass through a specific coordinate at 1 m/s is 1/200 seconds shorter than 1/20 seconds. Here, an ink heating range of the high-frequency dielectric heating device 100 in 5 mm is 12.5 mm×12.5 mm and four of the devices are arranged to heat a range of 50 mm×50 mm at the same time. The high-frequency dielectric heating devices 100 in 50 mm take 1/20 seconds to pass the predetermined coordinate and the time necessary for drying may be secured.

In FIG. 5, the high-frequency dielectric heating devices 100 are arranged in five columns in directions perpendicular to the scanning directions MS of the carriage 150. This is because the nozzle row of the liquid ejection head 160 has a length and one high-frequency dielectric heating device 100 in 5 mm×5 mm does not cover the length. Here, the length of the nozzle row is 70 mm and five of the high-frequency dielectric heating devices 100 are arranged to cover the length.

The recording apparatus 200 of the embodiment is particularly effective when the recording medium M is a material such as a film through which a liquid such as ink does not soak or hardly soak. However, even when the recording medium M such as paper that absorbs a liquid is used, the drying effect may be sufficiently obtained.

### 3. Experimental Examples

As below, the present disclosure will be explained more specifically using experimental examples, however, the present disclosure are not limited to these experimental examples.

### 3.1. Frequency Characteristics of Respective Elements of High-Frequency Dielectric Heating Device

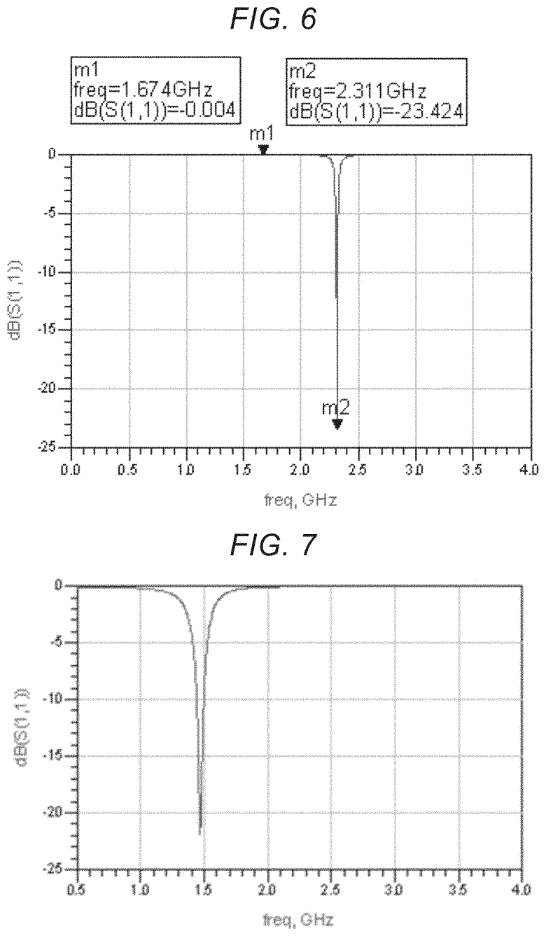

FIG. 6 shows a simulation result of a return loss of an equivalent circuit of an antenna. In FIG. 6, m1 and m2 indicate the following cases:

m2: without a recording medium or liquid, the antenna 50 is equivalently a capacitor of about 0.5 pF; and

m1: with a coating of a liquid having a thickness of 21 μm on a recording medium (polyethylene terephthalate), the antenna 50 is equivalently a capacitor of about 1.0 pF.

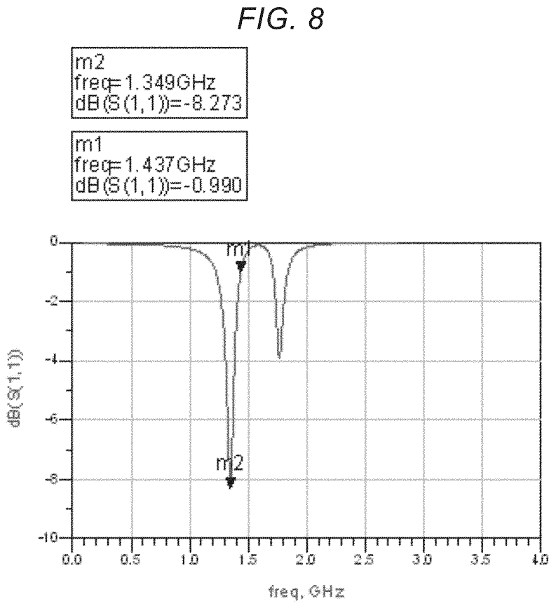

The antenna was the same as the antenna 50 shown in FIGS. 1 and 2. FIG. 7 shows a simulation result of a return loss of a first resonance circuit. The first resonance circuit was the same as the first resonance circuit P1 shown in FIGS. 1 and 2. FIG. 8 shows a simulation result of a return loss of a high-frequency dielectric heating device having the first resonance circuit. The high-frequency dielectric heating device was the same as the high-frequency dielectric heating device 100 shown in FIGS. 1 and 2.

First, from the result of the first resonance circuit P1 in FIG. 7, in the graph of the return loss of the antenna, the return loss is the minimum around 1.5 GHz, however, without the resistor R1 (see FIGS. 1 and 2), the minimum point does not exist. With the resistor R1, S11 has a real part resistance value at the resonance frequency and the graph has a valley shape.

From FIGS. 6 to 8, the first resonance circuit P1 itself has a resonance frequency and input impedance is 50Ω at the frequency. Further, the antenna 50 is coupled to the first resonance circuit P1, the resonance frequency of the antenna 50 is purposely shifted from the resonance frequency of the first resonance circuit P1, the high-frequency dielectric heating device 100 is driven at the resonance frequency of the first resonance circuit P1, and thereby, heating may be performed not at the resonance frequency of the antenna 50 that largely varies depending on the situation of the heated object, but at the more stable resonance frequency of the first resonance circuit P1. Thereby, stable heating can be performed at the fixed frequency, and heating with high efficiency can be performed without changes in heating efficiency, the resonance frequency of the first resonance circuit, and the resonance frequency of the antenna 50 when the resistor R3 is designed to be smaller.

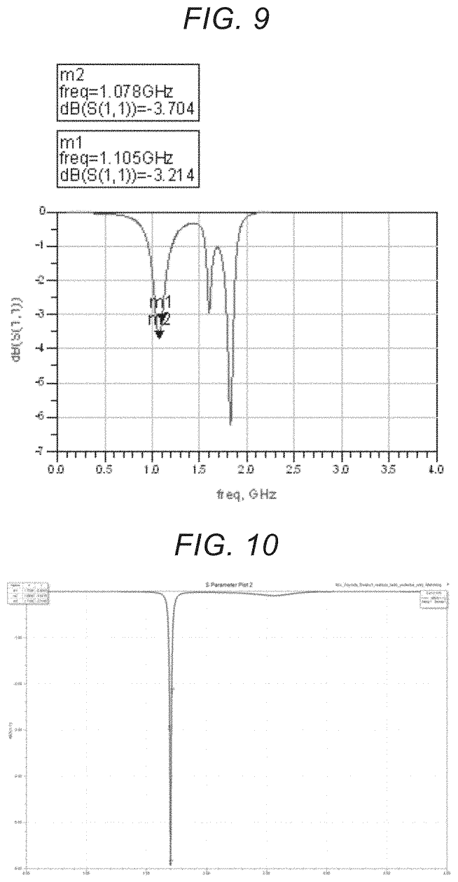

A simulation of a plurality of resonance circuits parallel-coupled to the antenna 50 was performed. The plurality of resonance circuits are parallel-coupled, and thereby, variations of the resonance frequency of the antenna 50 due to the state of the liquid may be suppressed. FIG. 9 shows a simulation result of a return loss with respect to the high-frequency dielectric heating device 120 having the first resonance circuit P1 and the second resonance circuit P2. The high-frequency dielectric heating device is the same as the high-frequency dielectric heating device 120 shown in FIGS. 3 and 4.

From FIG. 9, it is known that variations of the resonance frequency of the antenna 50 due to the state of the liquid as an object to be heated may be suppressed using two resonance circuits, not the single resonance circuit. Here, in the equivalent circuit of the high-frequency dielectric heating device 120, the first electrode 10 and the second electrode 20 may be replaced by the capacitor C1 for consideration. Variations of the capacitance of the capacitor C1 due to the state of the liquid is considered as follows from an HFSS simulation.

Referring to FIGS. 8 and 9, m1 and m2 in FIGS. 8 and 9 indicate the following cases:

m1: without a recording medium or liquid, the antenna 50 is equivalently a capacitor of about 0.5 pF; and

m2: with a coating of a liquid having a thickness of 21 μm on a recording medium (polyethylene terephthalate), the antenna 50 is equivalently a capacitor of about 1.0 pF.

From FIG. 8, it is known that, as a result of the simulation of the return loss of the equivalent circuit when the single resonance circuit is mounted, there is a frequency difference of 88 MHz between the presence and the absence of the recording medium and the liquid (when the recording medium and the liquid are present, smaller by 88 MHz). On the other hand, as shown in FIG. 9, it is known that, as a result of the simulation of the return loss of the equivalent circuit when the two resonance circuits are mounted, there is a frequency difference of 27 MHz between the presence and the absence of the recording medium and the liquid (when the recording medium and the liquid are present, smaller by 27 MHz) and the frequency difference is reduced. This shows that, when the two resonance circuits are provided in the high-frequency dielectric heating device, even when the shape and the composition of the object to be heated largely vary, heating efficiency may be kept good to follow the variations without complex control, that is, even when the frequency characteristics or the impedance of the antenna varies, high-frequency power may be stably supplied to the antenna via the first resonance circuit and the second resonance circuit.

Note that, as the result of the simulation of the return loss of the equivalent circuit when the single resonance circuit is mounted, there is the frequency difference of 88 MHz between the presence and the absence of the recording medium and the liquid, however, the frequency difference is sufficiently smaller than that in the case without the resonance circuit as shown in FIG. 6 and a remarkable effect is obtained by mounting of the single resonance circuit.

### 3.2. Similarity of Characteristics of Equivalent Circuit to Simulation Result

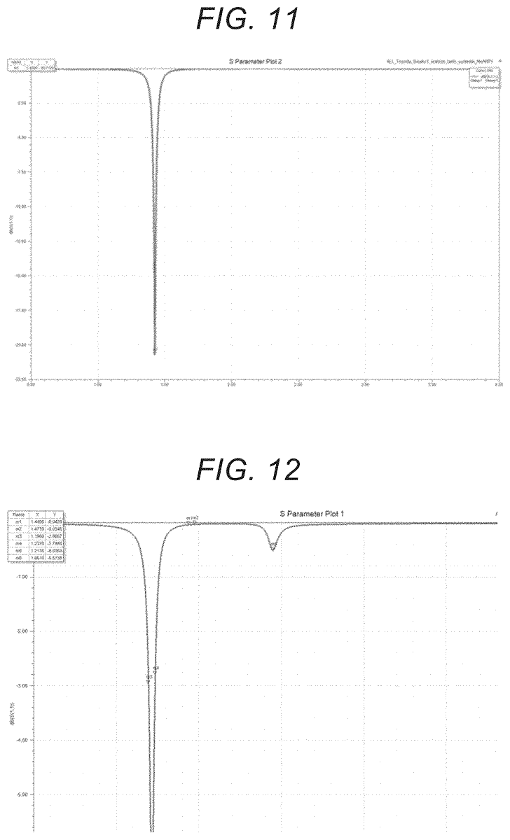

The similarity of the equivalent circuit of the high-frequency dielectric heating device to characteristics calculated by an electromagnetic field simulation (HFSS) is shown as below. Here, three of the antenna 50, the first resonance circuit P1, and the high-frequency dielectric heating device 100 were respectively verified. FIGS. 10, 11, and 12 show electromagnetic field simulation results (HFSS) of the equivalent circuits of the antenna 50, the first resonance circuit P1, and the high-frequency dielectric heating device 100, respectively.

In respective comparisons between FIGS. 10 and 6, FIGS. 11 and 7, FIGS. 12 and 8, it is known that graph shapes of the electromagnetic field simulations (HFSS) and graph shapes of the frequency characteristics of the return loss substantially coincide with each other and the equivalent circuits used in this specification are appropriate as the equivalent circuits of the high-frequency dielectric heating device. Further, it is also known that the range of the antenna becomes wider to about 1.5 times by the coupling of the resonance circuit. It is considered that this behavior shows an action that facilitates staying of the resonance frequency of the high-frequency dielectric heating device within the range when the state of the liquid as the object to be heated varies.

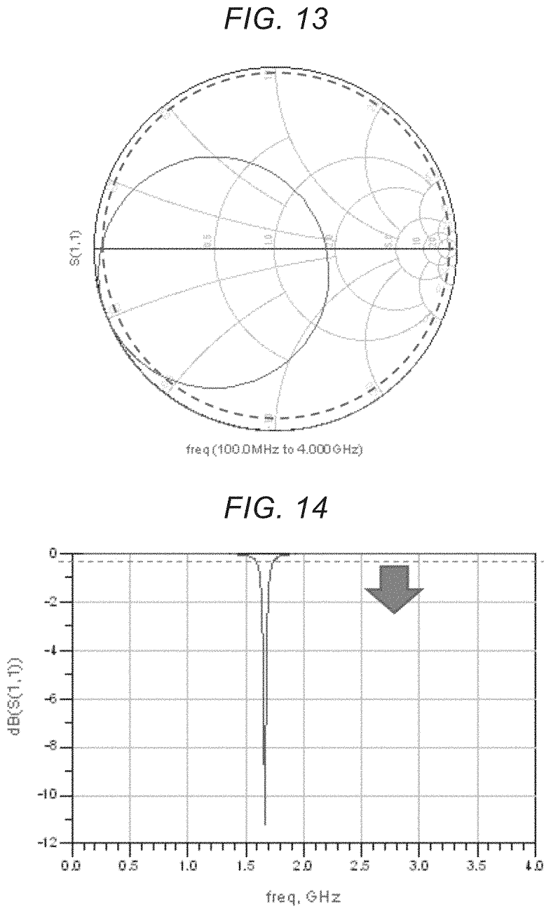

FIG. 13 is a Smith chart of the impedance of the antenna 50. FIG. 14 is a graph of frequency characteristics of the return loss of the antenna 50.

A circle of a solid line inscribed in an outer circumference of the Smith chart in FIG. 13 shows that the impedance has only an imaginary component, but no real part and a signal is never input from a line of 5011. Further, a circle of a dotted line drawn inside without contact with the outer circumference of the Smith chart in FIG. 13 is a boundary at which the return loss is 0.1 dB, that is, the return is −0.1 dB. On the other hand, a straight line drawn by a dotted line under the base line of 0 dB of the frequency characteristics in FIG. 14 shows the same as that shown by the circle of the dotted line in the Smith chart in FIG. 13, a boundary at which the return loss is 0.1 dB, that is, the return is −0.1 dB.

The outer circumference of the Smith chart shows that high-frequency wave input from the supply line of 50Ω is totally reflected by the antenna. However, even at slightly inside of the outer circumference of the Smith chart, in principle, the reflection may be made to be zero by adjustment of the constant of the matching circuit. The high-frequency dielectric heating device according to the present disclosure can use a frequency inside of the dotted line inside of the Smith chart in FIG. 13, that is, lower than the dotted line of the graph of the frequency characteristics in FIG. 14 (see an arrow).

Note that the outer circumference of the Smith chart in FIG. 13 shows 0 dB in the graph of the frequency characteristics in FIG. 14, and the center of the Smith chart in FIG. 13 shows −∞ dB in the graph of the frequency characteristics in FIG. 14. Here, the circle shown by the solid line in the Smith chart in FIG. 13 does not pass the center of the Smith chart, and the bottom of the valley of the graph of the return loss in FIG. 14 is −11 dB.

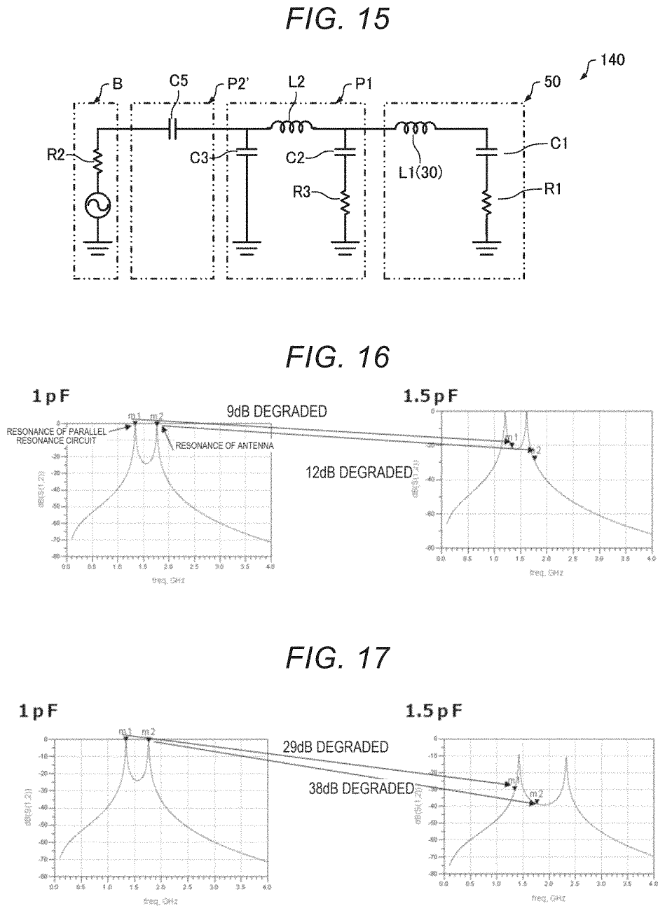

FIG. 15 shows an equivalent circuit of a high-frequency dielectric heating device 140 formed by insertion of a capacitor C5 in series between the high-frequency voltage generation circuit B and the first resonance circuit P1 of the above described high-frequency dielectric heating device 100. For example, it was confirmed that the configuration of the equivalent circuit shown in FIG. 15 is employed, and thereby, a second resonance circuit P2′ having an effect similar to that of the above described second resonance circuit P2 may be formed and peaks of the return losses of the first resonance circuit P1 and the second resonance circuit P2′ may be overlapped. In the case of the circuit configuration, the resonance power of the resonance circuit became stronger and heating efficiency of the liquid at the resonance frequency of the resonance circuit became better.

Regarding the equivalent circuit shown in FIG. 15, an improvement of an amount of energy transmission from the high-frequency voltage generation circuit B to a heated object such as ink by the present disclosure is explained. Here, assuming that C1 increases from a reference value 1 pF to 1.5 pF or decreases to 0.5 pF as a variation of the antenna characteristics depending on an ink pattern or the like, frequency characteristics of the amount of energy transmission are shown in FIGS. 16 and 17, respectively. Such a large capacitance variation is not produced in a real machine, however, the capacitance is varied by ±0.5 pF for clearly showing the effect of the present disclosure.

Here, variations of transmission gain when, as a matching circuit, only one capacitor is parallel-coupled to the antenna 50 and a parallel resonance circuit according to the present disclosure is not used is a decrease of 23 dB at 1.5 pF and a decrease of 32 dB at 0.5 pF. Further, in FIGS. 16 and 17, the left peaks of double peaks in the respective graphs are peaks due to the parallel resonance circuit and the right peaks are peaks due to the antenna 50. In the case of FIG. 16, at the peak of the parallel resonance circuit, C1 varies by +0.5 pF and the transmission gain decreases by 9 dB and the peak of the antenna 50 decreases by 12 dB. It is known that both are improved relative to the decreases of 23 dB in the case without using the parallel resonance circuit, however, the amount of attenuation of the peak of the parallel resonance circuit is relaxed by 3 dB (=12 dB—9 dB) relative to the peak of the antenna 50. Similarly, in the case of FIG. 17, at the peak of the parallel resonance circuit, C1 varies by −0.5 pF and the transmission gain decreases by 29 dB, and the peak of the antenna 50 decreases by 38 dB. It is known that the peak of the antenna 50 decreases by 38 dB and is degraded relative to the decrease of 32 dB in the case without using the parallel resonance circuit, however, the peak of the parallel resonance circuit decreases by 29 dB and the amount of attenuation is relaxed by 9 dB (=38 dB—29 dB) relative to the peak of the antenna 50 and 3 dB (=32 dB—29 dB) relative to that in the case without using the parallel resonance circuit.

The above described embodiments and modified examples are just examples and the present disclosure is not limited to those. For example, the respective embodiments and the respective modified examples can be appropriately combined.

The present disclosure includes substantially the same configurations e.g. configurations having the same functions, methods, and results or configurations having the same purposes and effects as the configurations explained in the embodiments. Further, the present disclosure includes configurations in which non-essential parts of the configurations explained in the embodiments are replaced. Furthermore, the present disclosure includes configurations that may exert the same effects or achieve the same purposes as those of the configurations explained in the embodiments. In addition, the present disclosure includes configurations formed by addition of known techniques to the configurations explained in the embodiments.

The following details are derived from the above described embodiments and modified examples.

An aspect of a high-frequency dielectric heating device includes a high-frequency power source generating a high-frequency voltage, a first resonance circuit electrically coupled to the high-frequency power source and outputting a first resonance voltage based on the high-frequency voltage, and an antenna having a capacitor including a first electrode and a second electrode and a coil, electrically coupled to the first resonance circuit, and supplied with the first resonance voltage, wherein one end of the coil is electrically coupled to the first electrode and the other end is electrically series-coupled to the first resonance circuit, the first resonance circuit includes a capacitor having fixed capacitance, a resonance frequency of the first resonance circuit is different from a resonance frequency of the antenna, a frequency range in which a return loss of the first resonance circuit is equal to or less than 0.1 dB and a frequency range in which a return loss of the antenna is equal to or less than 0.1 dB overlap, and a frequency of the high-frequency voltage is in the frequency range in which the return loss of the first resonance circuit is equal to or less than 0.1 dB.

According to the high-frequency dielectric heating device, even when the shape and the composition of an object to be heated largely vary, heating efficiency may be stably maintained to be good for the variations without complex control to adjust the circuit constant at each time. That is, even when the frequency characteristics or the impedance of the antenna varies, high-frequency power may be stably supplied to the antenna via the first resonance circuit.

In the aspect of the high-frequency dielectric heating device, a minimum separation distance between the first electrode and the second electrode may be equal to or smaller than one tenth of a wavelength of electromagnetic wave radiated from the antenna.

According to the high-frequency dielectric heating device, intensity of the electromagnetic wave radiated from the antenna may be made very strong near the first electrode and the second electrode.

In the aspect of the high-frequency dielectric heating device, the first resonance voltage may be applied to the first electrode and a reference potential may be applied to the second electrode.

According to the high-frequency dielectric heating device, tolerance to disturbances due to variations in shape of a heated object or the like may be made better.

In the aspect of the high-frequency dielectric heating device, a second resonance circuit electrically coupled between the high-frequency power source and the first resonance circuit and outputting a second resonance voltage based on the high-frequency voltage is provided, and the first resonance circuit may output the first resonance voltage based on the second resonance voltage, the second resonance circuit may include a capacitor having fixed capacitance, a resonance frequency of the second resonance circuit may be different from the resonance frequency of the first resonance circuit, a frequency range in which a return loss of the second resonance circuit is equal to or less than 0.1 dB and the frequency range in which the return loss of the first resonance circuit is equal to or less than 0.1 dB may overlap, and the frequency of the high-frequency voltage may be in the frequency range in which the return loss of the seconds resonance circuit is equal to or less than 0.1 dB.

According to the high-frequency dielectric heating device, even when the shape and the composition of the object to be heated largely vary, heating efficiency may be made better to follow the variations without complex control. That is, even when the frequency characteristics or the impedance of the antenna varies, high-frequency power may be supplied more stably to the antenna via the two circuits of the second resonance circuit and the first resonance circuit.

In the aspect of the high-frequency dielectric heating device, the first resonance circuit may include a coil and a capacitor coupled in a π-shape.

According to the high-frequency dielectric heating device, the characteristics of the first resonance circuit become better and the heating efficiency is further improved.

In the aspect of the high-frequency dielectric heating device, the second resonance circuit may include a coil and a capacitor coupled in a π-shape.

According to the high-frequency dielectric heating device, the characteristics of the second resonance circuit become better and the heating efficiency is further improved.

In the aspect of the high-frequency dielectric heating device, one end of the coil may be electrically coupled to the first electrode and the other end may be coupled to a reference potential, and the second electrode may be electrically series-coupled to the first resonance circuit.

An aspect of a recording apparatus includes the high-frequency dielectric heating device according to the above described aspect, a carriage, and a liquid ejection head, wherein at least a heater of the high-frequency dielectric heating device and the liquid ejection head are mounted on the carriage, and a thin film of a liquid ejected from the liquid ejection head and attached to a recording medium is dried by the high-frequency dielectric heating device.

According to the recording apparatus, even when the shape and the composition of the object to be heated largely vary, heating efficiency may be made better to follow the variations without complex control. That is, even when the frequency characteristics or the impedance of the antenna varies, high-frequency power may be stably supplied to the antenna via the first resonance circuit. Thereby, the liquid attached to the recording medium may be efficiently dried.

What is claimed is:

1. A high-frequency dielectric heating device comprising:
a high-frequency power source generating a high-frequency voltage;
a first resonance circuit electrically coupled to the high-frequency power source and outputting a first resonance voltage based on the high-frequency voltage; and
an antenna having a capacitor including a first electrode and a second electrode and a coil, electrically coupled to the first resonance circuit, and supplied with the first resonance voltage, wherein
one end of the coil is electrically coupled to the first electrode and the other end is electrically series-coupled to the first resonance circuit,
the first resonance circuit includes a capacitor having fixed capacitance,
a resonance frequency of the first resonance circuit is different from a resonance frequency of the antenna,
a frequency range in which a return loss of the first resonance circuit is equal to or less than 0.1 dB and a frequency range in which a return loss of the antenna is equal to or less than 0.1 dB overlap, and
a frequency of the high-frequency voltage is in the frequency range in which the return loss of the first resonance circuit is equal to or less than 0.1 dB.

2. The high-frequency dielectric heating device according to claim 1, wherein
a minimum separation distance between the first electrode and the second electrode is equal to or smaller than one tenth of a wavelength of electromagnetic wave radiated from the antenna.

3. The high-frequency dielectric heating device according to claim 1, wherein
the first resonance voltage is applied to the first electrode and a reference potential is applied to the second electrode.

4. The high-frequency dielectric heating device according to claim 1, further comprising a second resonance circuit electrically coupled between the high-frequency power source and the first resonance circuit and outputting a second resonance voltage based on the high-frequency voltage, wherein
the first resonance circuit outputs the first resonance voltage based on the second resonance voltage,
the second resonance circuit includes a capacitor having fixed capacitance,
a resonance frequency of the second resonance circuit is different from the resonance frequency of the first resonance circuit,
a frequency range in which a return loss of the second resonance circuit is equal to or less than 0.1 dB and the frequency range in which the return loss of the first resonance circuit is equal to or less than 0.1 dB overlap, and
the frequency of the high-frequency voltage is in the frequency range in which the return loss of the second resonance circuit is equal to or less than 0.1 dB.

5. The high-frequency dielectric heating device according to claim 1, wherein
the first resonance circuit includes a coil and a capacitor coupled in a π-shape.

6. The high-frequency dielectric heating device according to claim 4, wherein
the second resonance circuit includes a coil and a capacitor coupled in a π-shape.

7. The high-frequency dielectric heating device according to claim 1, wherein
one end of the coil is electrically coupled to the first electrode and the other end is coupled to a reference potential, and
the second electrode is electrically series-coupled to the first resonance circuit.

8. A recording apparatus comprising:
the high-frequency dielectric heating device according to claim 1;
a carriage; and
a liquid ejection head, wherein
at least a heater of the high-frequency dielectric heating device and the liquid ejection head are mounted on the carriage, and
a thin film of a liquid ejected from the liquid ejection head and attached to a recording medium is dried by the high-frequency dielectric heating device.
